(19) United States
(12) Patent Application Publication
(10) Pub. No.: US 2018/0250885 A1
(43) Pub. Date: Sep. 6, 2018

(54) THREE-DIMENSIONAL BUILDING APPARATUS AND THREE-DIMENSIONAL BUILDING METHOD

(71) Applicant: MIMAKI ENGINEERING CO., LTD., Nagano (JP)

(72) Inventors: Hikaru Mugishima, Nagano (JP); Kazuhiro Ochi, Nagano (JP)

(73) Assignee: MIMAKI ENGINEERING CO., LTD., Nagano (JP)

(21) Appl. No.: 15/905,831

(22) Filed: Feb. 27, 2018

(30) Foreign Application Priority Data
Mar. 1, 2017 (JP) 2017-038649

(51) Int. Cl. B29C 64/40; B29C 64/112; B33Y 10/00; B33Y 30/00; B29C 64/393; B33Y 50/02

(52) U.S. Cl. CPC B29C 64/40; B29C 64/112; B33Y 50/02; B33Y 30/00; B29C 64/393; B33Y 10/00

(57) ABSTRACT

Provided are a three-dimensional building apparatus and a three-dimensional building method capable of generating a three-dimensional object with sufficient adhesion between unit layers without performing a special process before curing a model material and a support material. A three-dimensional building apparatus includes: a stage configured to hold a deposition structure formed by depositing unit layers; an ejector configured to eject droplets of a curable model material and a curable support material toward the uppermost surface of the deposition structure; a curing device configured to cure the uppermost surface; and an ejection controller configured to perform an ejection control of the ejection device so as to reduce the deposition rate on the lower layer side of the workpiece and to increase the deposition rate on the upper layer side of the workpiece.

### CROSS REFERENCE TO RELATED APPLICATIONS

This application claims the priority benefit of Japanese Patent Application No. 2017-038649, filed on Mar. 1, 2017. The entirety of the above-mentioned patent application is hereby incorporated by reference herein and made a part of this specification.

### TECHNICAL FIELD

The present disclosure relates to a three-dimensional building apparatus and a three-dimensional building method for generating a three-dimensional object formed of a curable model material, by removing a support member formed of a curable support material from a workpiece obtained by successively depositing unit layers including the model material and/or the support material.

### BACKGROUND ART

Three-dimensional building apparatuses (called 3D printers) have recently been developed, which generate an object having a three-dimensional shape by successively depositing layers in units of slices (hereinafter referred to as unit layers) along the vertical direction while solidifying the layers. A three-dimensional object formed of a model material is generated typically by removing a support member formed of a support material from a workpiece obtained by successively depositing unit layers including the model material and/or the support material.

When a three-dimensional object is built directly on a work surface of a stage, the bottom surface of the workpiece may be deformed when removed from the stage, resulting in deterioration of quality of the three-dimensional object. Specifically, the surface shape of the work surface may be transferred to the bottom surface, or the bottom surface sticking to the work surface may be partially lost. In order to avoid such phenomena, a pedestal made of a support material that can be removed later may be disposed between the bottom surface and the work surface.

Meanwhile, the unit layers may interfere with each other due to differences in building conditions of the three-dimensional object, and the curing properties may vary to a non-negligible degree. In particular, differences in curing properties between the materials may cause distortion in the vicinity of the contact surface between the body of the object and the pedestal, and the adhesion of the body to the pedestal is likely to be reduced. As a result, separation between the body and the pedestal may occur during the course of formation of the workpiece, thereby reducing the reproducibility of the building position on the upper layer side.

U.S. Pat. No. 8,636,494 (see, for example, FIG. 3A, FIG. 4B, and FIG. 4C) proposes an apparatus that includes a heater (heating element) at a stage for heating from below a workpiece. According to the description, merging of different materials at the interface line is thus reduced, and the adhesion of the body to the pedestal is kept.

Patent Literature: U.S. Pat. No. 8,636,494

### SUMMARY

Unfortunately, the addition of a heater as in the apparatus proposed in U.S. Pat. No. 8,636,494 not only increases the manufacturing cost of the apparatus but also increases power consumption for driving the heater.

The present disclosure is made in view of the problem above and provides a three-dimensional building apparatus and a three-dimensional building method capable of generating a three-dimensional object with sufficient adhesion between unit layers without performing a special process before curing a model material and a support material.

A “three-dimensional building apparatus” according to the present disclosure generates a three-dimensional object formed of a curable model material by removing a support member formed of a curable support material from a workpiece obtained by successively depositing unit layers including the curable model material and/or the curable support material. The three-dimensional building apparatus includes: a stage configured to hold a deposition structure formed by depositing the unit layers; an ejector configured to eject droplets of the curable model material and the curable support material toward an uppermost surface of the deposition structure while moving relative to the stage; a curing device configured to cure the uppermost surface formed through ejection of the droplets; and an ejection controller, configured to perform an ejection control of the ejector so as to reduce a deposition rate on a lower layer side of the workpiece and to increase a deposition rate on an upper layer side of the workpiece.

The shearing stress acting between the unit layers tends to increase on the lower layer side and decrease on the upper layer side due to the effect of the weight of the workpiece. Ejection control of the ejector is then performed such that the deposition rate is reduced on the lower layer side of the workpiece, whereby the time required for the unit layers on the lower layer side to be completely cured becomes relatively short, and variation in curing properties is less likely to occur. Accordingly, a three-dimensional object with sufficient adhesion between the unit layers can be generated without performing a special process before curing the model material and the support material.

Ejection control of the ejector is performed such that the deposition rate is increased on the upper layer side of the workpiece, so that the time required for completion is reduced accordingly, and the productivity of the workpiece is improved. It should be noted that on the upper layer side where the stress due to the weight of the workpiece is low, even when the time required for curing is relatively long, the adhesion described above is less affected.

In an embodiment, the ejection controller performs the ejection control of the ejector, so as to reduce a deposition interval and reduce an ejection amount of the droplets on the lower layer side of the workpiece and to increase a deposition interval and increase an ejection amount of the droplets on the upper layer side of the workpiece. The deposition rate can be changed freely by variably controlling the deposition interval and the ejection amount, without substantially changing other ejection conditions.

In an embodiment, the support member that is part of the workpiece includes a pedestal disposed between the three-dimensional object and the stage. Differences in curing properties between the model material and the support material may cause distortion in the vicinity of the contact surface between the body of the three-dimensional object and the pedestal, and the adhesion of the body to the pedestal is likely to be reduced. Accordingly, the adhesion improvement effect described above is more significant.

In a “three-dimensional building method” according to the present disclosure, a three-dimensional object formed of a curable model material is generated by removing a support member formed of a curable support material from a workpiece obtained by successively depositing unit layers including the curable model material and/or the curable support material. The three-dimensional building method includes: an ejecting step of ejecting droplets of the curable model material and the curable support material toward an uppermost surface of a deposition structure formed by depositing the unit layers, while moving relative to a stage configured to hold the deposition structure; a curing step of curing the uppermost surface formed through ejection of the droplets; and a control step of performing an ejection control so as to reduce a deposition rate on a lower layer side of the workpiece and to increase a deposition rate on an upper layer side of the workpiece.

The three-dimensional building apparatus and the three-dimensional building method according to the present disclosure can generate a three-dimensional object with sufficient adhesion between unit layers without performing a special process before curing a model material and a support material.

### BRIEF DESCRIPTION OF THE DRAWINGS

FIGS. 1A and 1B are schematic diagrams illustrating the main part of a three-dimensional building apparatus according to a first embodiment.

FIG. 2 is an electrical block diagram of the three-dimensional building apparatus illustrated in FIGS. 1A and 1B.

FIGS. 3A and 3B are diagrams illustrating a mode of a three-dimensional object and a workpiece.

FIG. 4 is a flowchart for explaining the operation of the three-dimensional building apparatus illustrated in FIGS. 1A and 1B and FIG. 2.

FIG. 5 is a diagram illustrating the position dependency of the deposition rate.

FIGS. 6A to 6C are diagrams illustrating partial structure examples of ejection data.

FIGS. 7A and 7B are partially enlarged cross-sectional views of the workpiece in the vicinity of a contact surface between a body and a pedestal.

### DESCRIPTION OF EMBODIMENTS

A three-dimensional building apparatus according to the present disclosure will be described below, with suitable embodiments in relation to a three-dimensional building method, with reference to the accompanying drawings.

<Configuration of Main Part of Three-Dimensional Building Apparatus 10>

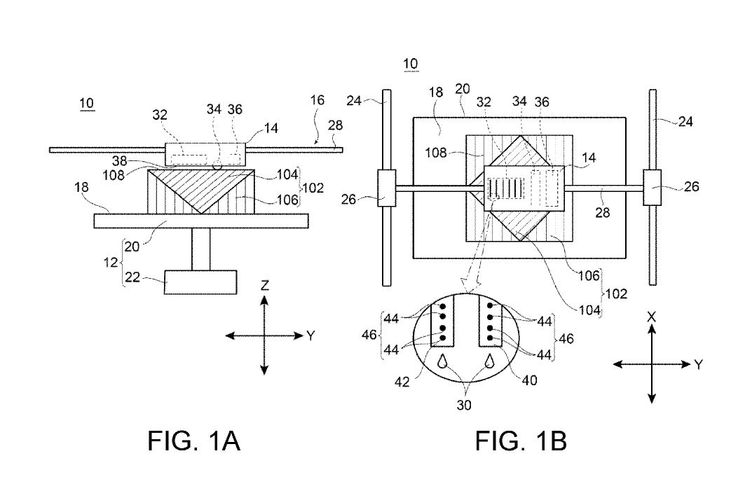

FIGS. 1A and 1B are schematic diagrams illustrating the main part of a three-dimensional building apparatus 10 according to the present embodiment. More specifically, FIG. 1A is a schematic side view of the three-dimensional building apparatus 10, and FIG. 1B is a schematic plan view of the three-dimensional building apparatus 10. The figures depict a deposition structure 102 that is a three-dimensional object 100 in the process of production.

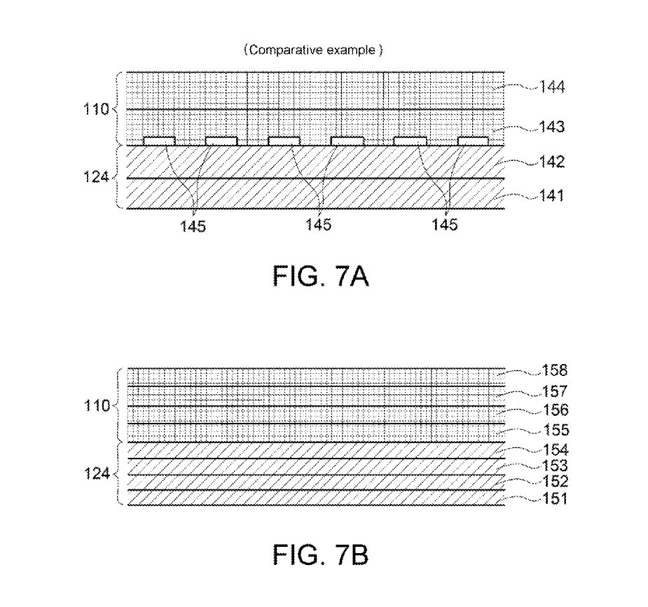

The deposition structure 102 is forming with a model material 104 that is a raw material of the three-dimensional object 100 and a support material 106 that supports the model material 104 from the outside or the inside. More specifically, the deposition structure 102 is forming by successively depositing unit layers 151 to 158 (see FIG. 7B) including the model material 104 and/or the support material 106 along the vertical direction.

The three-dimensional building apparatus 10 includes a stage unit 12 on which the deposition structure 102 is placed, a carriage 14 in which an ejection mechanism for the model material 104 and the support material 106 is installed, and a carriage driver 16 that drives the carriage 14 in the X direction and the Y direction.

The stage unit 12 includes a stage 20 having a flat work surface 18 and a stage driver 22 that moves the stage 20 in a direction (the Z direction) normal to the work surface 18. The carriage driver 16 includes a pair of guide rails 24 and 24 (X bars) extending parallel to the X direction, two sliders 26 and 26 movable along the respective guide rails 24, and a carriage rail 28 (Y bar) running between the two sliders 26 and 26 and extending in the Y direction.

The carriage 14 is movable along the carriage rail 28 having the carriage 14 attached thereto or along the guide rails 24 and 24 integrally with the carriage rail 28. The carriage 14 and the stage 20 are thus movable relative to the X direction, the Y direction, and the Z direction orthogonal to each other. In the present embodiment, the X direction and the Y direction agree with the “horizontal direction”, the Z direction agrees with the “vertical direction”, and the three directions are orthogonal to each other.

In the carriage 14, an ejection unit 32 (an ejector) that ejects a flowable model material 104 and a flowable support material 106 (which hereinafter may be collectively referred to as “droplets 30”) toward an uppermost surface 108 of the deposition structure 102, a planarizing roller 34 (a planarizer) that planarizes the uppermost surface 108, and a curing unit 36 (a curing device) that cures the droplets 30 on the uppermost surface 108 are installed.

The ejection unit 32 has an ejection surface 38 located to be opposed to the work surface 18 or the uppermost surface 108. The ejection unit 32 includes a plurality of ejection heads 40 that eject the model material 104 of the same or different colors and one ejection head 42 that ejects the support material 106. A variety of methods may be employed as a mechanism for ejecting droplets 30 with the ejection heads 40 and 42. For example, a method of ejecting droplets 30 through deformation of an actuator including a piezoelectric element may be employed. Alternatively, a method of ejecting droplets 30 with pressure caused by bubbles produced by heating the model material 104 or the support material 106 with a heater (heating element) may be employed.

The ejection heads 40 and 42 each have a nozzle row 46 having a plurality of nozzles 44 arranged in a row along the arrangement direction (in the example in the figures, the X direction) on the ejection surface 38 side. When the ejection unit 32 includes six ejection heads 40, for example, the six ejection heads 40 eject droplets 30 of the model material 104 colored in cyan (C), magenta (M), yellow (Y), black (K), clear (CL), and white (W).

The curing unit 36 is a device that applies a variety of energies to cure the droplets 30 of the model material 104. For example, when the model material 104 is an ultraviolet (UV) curable resin, the curing unit 36 includes a UV light source that applies ultraviolet rays as optical energy. When the model material 104 is a thermosetting resin, the curing unit 36 includes a heating device for applying thermal energy and, if necessary, a cooling device for cooling the deposition structure 102.

A rare gas discharge lamp, a mercury discharge lamp, a fluorescent lamp, a light emitting diode (LED) array, and the like may be used as the UV light source. The support material 106 is made of a material that can be removed without altering the three-dimensional object 100, such as water swelling gel, wax, thermoplastic resin, water-soluble material, and soluble material.

<Electrical Block Diagram of Three-Dimensional Building Apparatus 10>

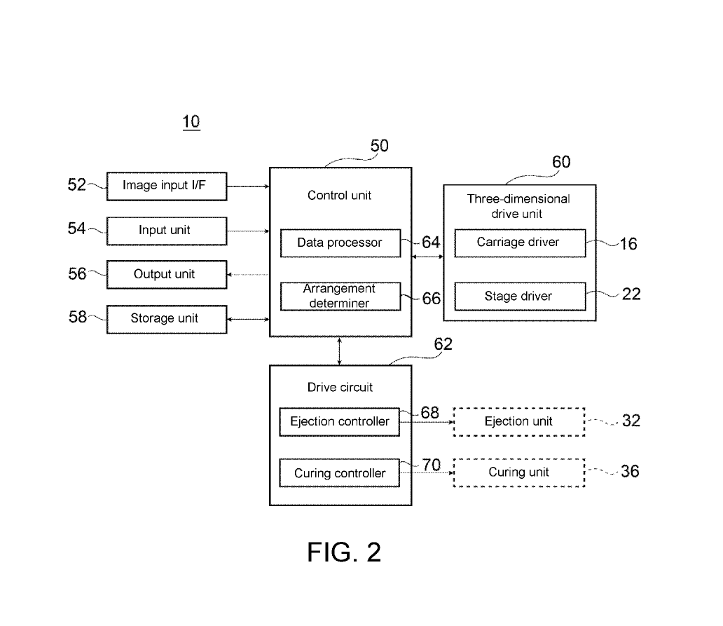

FIG. 2 is an electrical block diagram of the three-dimensional building apparatus 10 illustrated in FIGS. 1A and 1B. The three-dimensional building apparatus 10 includes, in addition to the carriage driver 16, the stage driver 22, the ejection unit 32, and the curing unit 36 illustrated in FIGS. 1A and 1B, a control unit 50, an image input interface (I/F) 52, an input unit 54, an output unit 56, a storage unit 58, a three-dimensional drive unit 60, and a drive circuit 62.

The image input I/F 52 is configured with a serial I/F or a parallel I/F and receives an electrical signal including image information representing a three-dimensional object 100 from a not-illustrated external device. The input unit 54 includes a mouse, a keyboard, a touch sensor, or a microphone. The output unit 56 includes a display or a speaker.

The storage unit 58 is configured with a non-transitory and computer-readable recording medium. Here, the computer-readable recording medium is a portable medium such as optical magnetic disc, ROM, CD-ROM, or flash memory, or a storage device such as hard disk contained in a computer system. The recording medium may be the one that retains a program dynamically for a short time or the one that retains a program for a certain time.

The three-dimensional drive unit 60 drives at least one of the stage 20 and the ejection unit 32 to move the ejection unit 32 relative to the stage 20 in three-dimensional directions. In the present embodiment, the three-dimensional drive unit 60 includes the carriage driver 16 that moves the ejection unit 32 in the X direction and the Y direction and the stage driver 22 that moves the stage 20 in the Z direction.

The control unit 50 is an arithmetic unit that controls the components included in the three-dimensional building apparatus 10 and is configured with, for example, a central processing unit (CPU), a graphics processing unit (GPU), or a micro-processing unit (MPU). The control unit 50 can read and execute a program stored in the storage unit 58 to implement the functions including a data processor 64 and an arrangement determiner 66.

The drive circuit 62 is an electric circuit that is electrically connected to the control unit 50 and drives each unit for executing a building process. In the present embodiment, the drive circuit 62 includes an ejection controller 68 that controls ejection of the ejection unit 32 and a curing controller 70 that controls curing of the curing unit 36.

The ejection controller 68 generates a drive waveform signal for actuators included in the ejection heads 40 and 42, based on ejection data supplied from the control unit 50, and outputs this waveform signal to the ejection unit 32. The curing controller 70 outputs a drive signal corresponding to the amount of application of energy (in the present embodiment, the radiation amount of ultraviolet rays) to the curing unit 36.

<Mode of Three-Dimensional Object 100 and Workpiece 120>

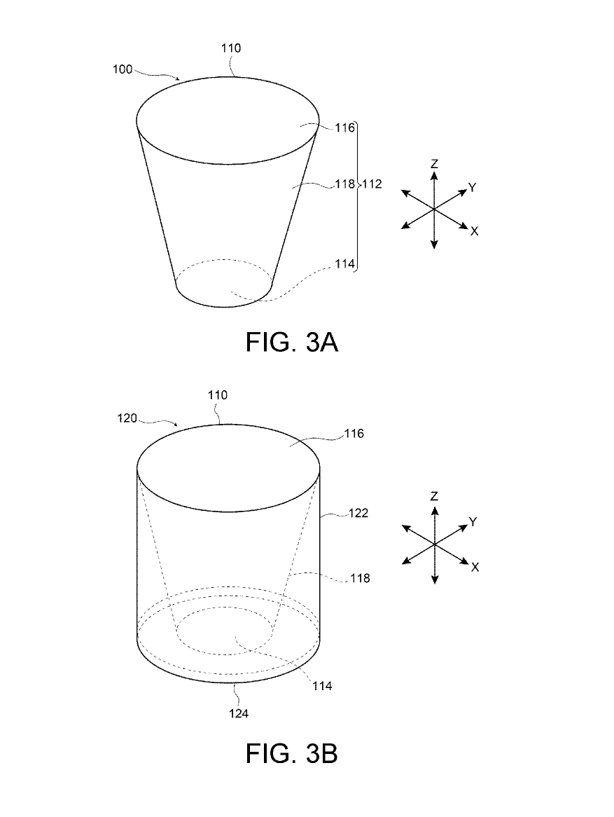

FIGS. 3A and 3B are diagrams illustrating a mode of the three-dimensional object 100 and the workpiece 120. More specifically, FIG. 3A is a front view of the three-dimensional object 100, and FIG. 3B is a front view of the workpiece 120. The workpiece 120 corresponds to a finished state of the deposition structure 102 and is an object from which the support material 106 (support member 122) has not yet been removed.

As illustrated in FIG. 3A, the three-dimensional object 100 formed of the model material 104 has an inverse truncated cone-shaped body 110. An outer surface 112 of the body 110 includes a circular bottom surface 114, an upper surface 116 having a diameter smaller than the bottom surface 114, and a side surface 118 coupling the bottom surface 114 with the upper surface 116.

The body 110 is made of a material that cures through a physical process or a chemical process, here, a UV curable resin. Examples of the UV curable resin include radical polymerization-type resins that cure through a radical polymerization reaction and cation polymerization-type resins that cure through a cationic polymerization reaction. Examples of the radical polymerization-type UV curable resins include urethane acrylates, acrylic acrylates, and epoxy acrylates.

As illustrated in FIG. 3B, the workpiece 120 includes the body 110 described above and the support member 122 that supports the body 110 from the outside. The support member 122 approximately has a pot-like shape that covers the entire outer surface 112 excluding the upper surface 116. It should be noted that the support member 122 includes a pedestal 124 disposed between the three-dimensional object 100 and the stage 20 (FIGS. 1A and 1B). The support member 122 is formed of a material that is UV curable as described above and can be removed without altering the three-dimensional object 100.

<Operation of Three-Dimensional Building Apparatus 10>

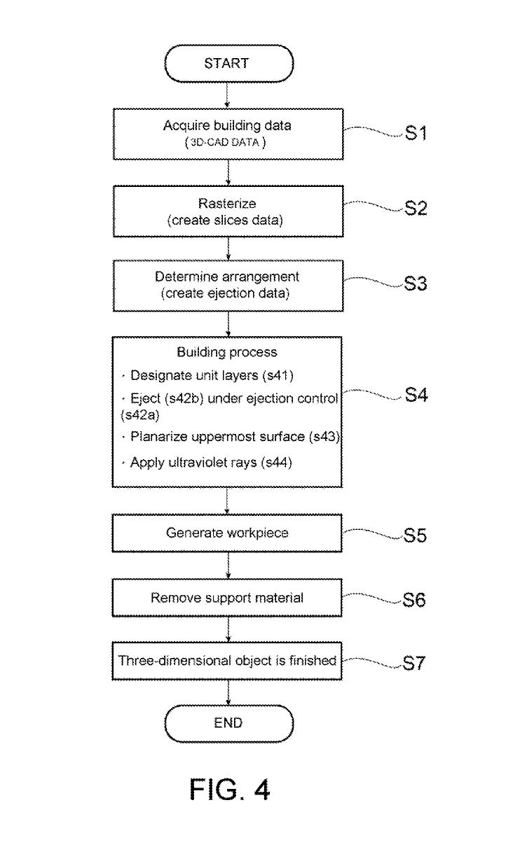

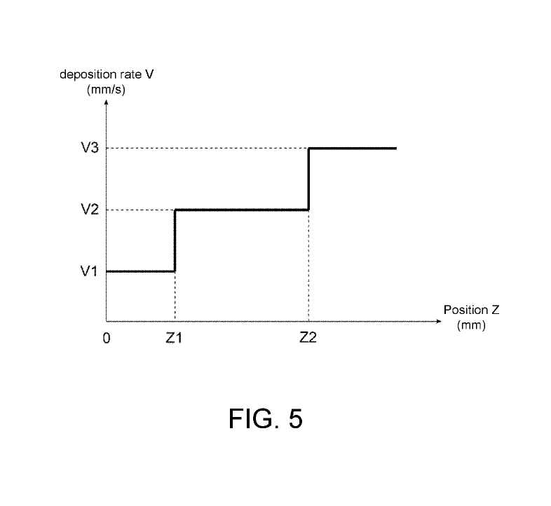

The operation of the three-dimensional building apparatus 10 illustrated in FIGS. 1A and 1B and FIG. 2 and the operation of generating the three-dimensional object 100 illustrated in FIG. 3A will now be described with reference to the flowchart in FIG. 4 and the diagrams in FIG. 5 to FIGS. 7A and 7B, as necessary.

In step S1 in FIG. 4, the control unit 50 acquires building data including 3D-computer aided design (CAD) data through the image input I/F 52. For example, the building data of a wire-frame model is composed of a combination of shape model data representing a three-dimensional frame of the three-dimensional object 100 and surface image data representing the image of the outer surface 112. The representation format of building data is not limited to a wire-frame model but may be a surface model or a solid model.

In step S2, the data processor 64 rasterizes the building data in vector graphics form acquired in step S1. Prior to this processing, the data processor 64 defines a work area representing a three-dimensional space in the X direction, the Y direction, and the Z direction and also determines three-dimensional resolutions (associates with the real size) of the X axis, the Y axis, and the Z axis of this work area.

Subsequently, the data processor 64 specifies the color in the frame (for example, white) and arranges the surface image on the frame surface using a known texture mapping technique. The data processor 64 thereafter converts the vector data with the surface image into raster data in accordance with the three-dimensional resolutions. The data processor 64 further executes a variety of image processing such as halftone processing including dithering and error diffusion, separation processing between similar colors/different colors, allocation processing of dot size (the amount of droplets), and processing of controlling the number of droplets. Individual slice data (hereinafter “slices data”) of unit layers 151 to 158 along one direction (the Z axis) is thus obtained.

In step S3, the arrangement determiner 66 determines the arrangement of the model material 104 and the support material 106 using the slices data obtained in step S2. Specifically, the arrangement determiner 66 arranges the support material 106 at a position where the model material 104 can be physically supported in the process of generating the workpiece 120. Through this arrangement process, “ejection data” is created, which indicates the presence/absence and the kind of droplets 30 at each three-dimensional position.

In the example illustrated in FIG. 3A, an outer wall (hereinafter referred to as overhang) protruding like a roof is formed on the side surface 118 of the body 110. When unit layers 151 to 158 are deposited layer by layer from the lower side to the upper side in the vertical direction to build an overhang, the model material 104 protruding outward falls under its own weight due to lack of physical strength for keeping the shape. It is then necessary to arrange the support material 106 between the work surface 18 and the side surface 118 for reinforcing and supporting each part of the side surface 118 from the lower side.

If the three-dimensional object 100 is directly built on the work surface 18, the bottom surface 114 of the body 110 may be deformed when the workpiece 120 is removed from the stage 20, resulting in deterioration of quality of the three-dimensional object 100. Specifically, the surface shape of the work surface 18 may be transferred to the bottom surface 114, or the bottom surface 114 sticking to the work surface 18 may be partially lost. It is then necessary to arrange the pedestal 124 made of the support material 106 that can be removed later, between the bottom surface 114 and the work surface 18.

In step S4, the three-dimensional building apparatus 10 executes a building process based on the ejection data created in step S3. Specifically, the three-dimensional building apparatus 10 generates the deposition structure 102 by successively depositing unit layers 151 to 158 including the model material 104 and the support material 106 along the Z direction while relatively moving the stage 20 and the ejection unit 32 in three-dimensional directions.

Here, [1] designation of the unit layers 151 to 158 to be formed (S41), [2] ejection of droplets 30 (S42b) under ejection control (S42a), [3] planarization of the uppermost surface 108 using the plana zing roller 34 (S43), and [4] curing of the uppermost surface 108 using the curing unit 36 (S44) are successively executed. The deposition structure 102 thus grows gradually along the vertical direction (the Z direction).

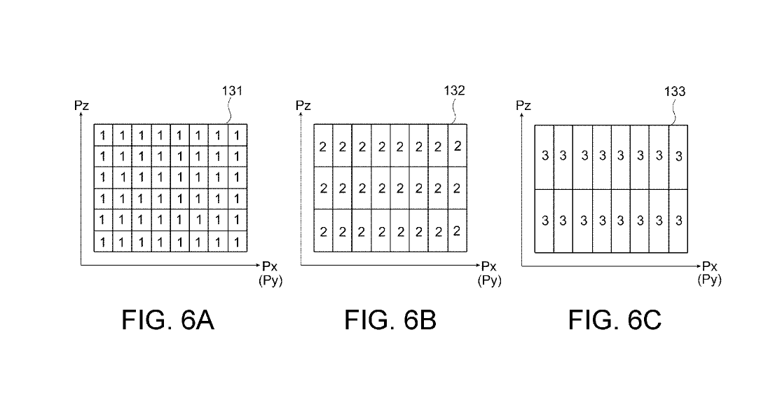

The ejection control (S42a) has a technical feature of changing a deposition rate V according to the unit layers 151 to 158. Here, the “deposition rate V” refers to the amount of growth of the deposition structure 102 per unit time (expressed in, for example, [mm/s]). A specific ejection control method will now be described below with reference to FIG. 5 and FIGS. 6A to 6C.

FIG. 5 is a diagram illustrating the position dependency of the deposition rate V. The horizontal axis of the graph represents the position in the Z direction (in mm), and the vertical axis of the graph represents the deposition rate V (in mm/s). Here, a position on the work surface 18 is a reference point, and the deposition direction of the unit layers 151 to 158 is a positive direction.

As can be understood from this diagram, the deposition rate V changes stepwise according to the position in the Z direction (the position of the unit layers 151 to 158). Specifically, when 0<Z<Z1 (the lower layer side), the deposition rate V=V1, when Z1<Z<Z2 (the intermediate layer side), the deposition rate V=V2, and when Z?Z2 (the upper layer side), the deposition rate V=V3. V1, V2, and V3 are positive values that satisfy the relation V1<V2<V3.

In this way, the ejection controller 68 performs ejection control of the ejection unit 32 so as to reduce the deposition rate V on the lower layer side of the workpiece 120 and increase the deposition rate V on the upper layer side of the workpiece 120. A specific example of the ejection data for performing this ejection control (more specifically, changing the deposition rate V) will now be described.

FIGS. 6A to 6C are diagrams illustrating partial structure examples of the ejection data. More specifically, FIG. 6A illustrates a data structure corresponding to the lower layer side, FIG. 6B illustrates a data structure corresponding to the intermediate layer side, and FIG. 6C illustrates a data structure corresponding to the upper layer side.

A first data row 131 illustrated in FIG. 6A is three-dimensional data configured with eight voxels in each horizontal direction (Px/Py) and six voxels in the height direction (Pz). The numerical value denoted in each voxel corresponds to a voxel value that identifies the size of the droplet 30 (the ejection amount of the model material 104). It should be noted that the length of the side of a rectangular cell is proportional to the voxel interval.

This voxel value is, for example, “3” for a large size, “2” for a middle size, “1” for a small size, and “0” for a position with no ejection. In this case, since all the voxel values are “1”, the first data row 131 indicates a state in which droplets 30 of a small size are ejected with no gap.

A second data row 132 illustrated in FIG. 6B is three-dimensional data configured with eight voxels in each horizontal direction (Px/Py) and three voxels in the height direction (Pz). As can be understood from this figure, the length of a rectangular cell in the Z direction is twice the length in FIG. 6A. Since all the voxel values are “2”, the second data row 132 represents a state in which droplets 30 of a middle size are ejected with no gap.

A third data row 133 illustrated in FIG. 6C is three-dimensional data configured with eight voxels in each horizontal direction (Px/Py) and two voxels in the height direction (Pz). As can be understood from this figure, the length of a rectangular cell in the Z direction is three times the length in FIG. 6A. Since all the voxel values are “3”, the third data row 133 represents a state in which droplets 30 of a large size are ejected with no gap.

In this way, the ejection controller 68 may perform ejection control of the ejection unit 32 so as to reduce the deposition interval and reduce the ejection amount of droplets 30 on the lower layer side (first data row 131) of the workpiece 120 and to increase the deposition interval and increase the ejection amount of droplets 30 on the upper layer side (third data row 133) of the workpiece 120. The deposition rate V can be changed freely by variably controlling the deposition interval and the ejection amount, without substantially changing other ejection conditions (for example, the resolution in the horizontal direction).

FIGS. 7A and 7B are partially enlarged cross-sectional views of the workpiece 120 in the vicinity of the contact surface between the body 110 and the pedestal 124. More specifically, FIG. 7A is a partially enlarged cross-sectional view of the workpiece 120 obtained through ejection control with a high deposition rate V, and FIG. 7B is a partially enlarged cross-sectional view of the workpiece 120 obtained through ejection control with a low deposition rate V.

As illustrated in FIG. 7A, in the vicinity of the contact surface (that is, the bottom surface 114), [1] a unit layer 141 of support material 106, [2] a unit layer 142 of support material 106, [3] a unit layer 143 of model material 104, and [4] a unit layer 144 of model material 104 are successively deposited. In this drawing, a plurality of gaps 145 are produced between the two unit layers 142 and 143. The reason for this is that the difference in curing properties between the model material 104 and the support material 106 causes distortion between the unit layers 142 and 143. Specifically, since the unit layers 141 to 144 are thick, the time required for completion of curing is relatively long, and variation in curing properties is likely to occur.

Subsequently, with the adhesion between the unit layers 142 and 143 kept low, a large shearing stress acts on the vicinity of the contact surface due to the weight of the workpiece 120 gradually growing. Then, if the unit layers 142 and 143 become separated, the reproducibility of the building position on the upper layer side is degraded, and the workpiece 120 having a desired three-dimensional shape may not be obtained.

By contrast, as illustrated in FIG. 7B, in the vicinity of the contact surface (that is, the bottom surface 114), [1] a unit layer 151 of support material 106, [2] a unit layer 152 of support material 106, [3] a unit layer 153 of support material 106, [4] a unit layer 154 of support material 106, [5] a unit layer 155 of model material 104, [6] a unit layer 156 of model material 104, [7] a unit layer 157 of model material 104, and [8] a unit layer 158 of model material 104 are successively deposited. The thickness of each of these unit layers 151 to 158 is about half that of the unit layers 141 to 144 (FIG. 7A).

As can be understood from this figure, no gap is produced between the layers of the unit layers 151 to 158. This is because each of a plurality of unit layers 151 to 158 that constitute the lower layer (for example, pedestal 124) is thinned by reducing the deposition rate V on the lower layer side, so that the time required for completion of curing becomes relatively short, and variation in curing properties is less likely to occur. Since the adhesion between the unit layers 151 to 158 is kept, separation of the unit layers 151 to 158 with the growth of the workpiece 120 can be prevented. As a result, the reproducibility of the building position is kept throughout the layers, and the workpiece 120 having a desired three-dimensional shape can be obtained.

The building process of the workpiece 120 is thus finished (step S4). When the support member 122 includes the pedestal 124, the adhesion improvement effect is more significant. This is because the adhesion of the body 110 to the pedestal 124 tends to decrease due to the difference in curing properties between the model material 104 and the support material 106.

In step S5 in FIG. 4, the workpiece 120 with the deposition structure 102 in a finished state is obtained (see FIG. 3B). Here, it should be noted that the workpiece 120 has a desired three-dimensional shape, in which the reproducibility of the building position of the three-dimensional object 100 is kept throughout the layers.

In step S6, the workpiece 120 obtained in the step S5 is subjected to the process of removing the support material 106 (support member 122). This removing process can be implemented through a physical process or a chemical process according to the properties of the support material 106, specifically, by dissolution in water, heating, chemical reaction, pressure washing, or electromagnetic radiation.

In step S7, the three-dimensional object 100 (see FIG. 3A) is finished. This three-dimensional object 100 has a desired three-dimensional shape.

### Effects of this Embodiment

As described above, the three-dimensional building apparatus 10 generates the three-dimensional object 100 formed of the curable model material 104 by removing the support member 122 formed of the curable support material 106 from the workpiece 120 obtained by successively depositing unit layers 151 to 158 including the model material 104 and/or the support material 106.

The three-dimensional building apparatus 10 includes [1] the stage 20 configured to hold the deposition structure 102 formed by depositing unit layers 151 to 158, [2] the ejection unit 32 configured to eject droplets 30 of the model material 104 and the support material 106 toward the uppermost surface 108 of the deposition structure 102 while moving relative to the stage 20, [3] the curing unit 36 configured to cure the uppermost surface 108 formed through ejection of the droplets 30, and [4] the ejection controller 68 configured to perform ejection control of the ejection unit 32 so as to reduce the deposition rate V on the lower layer side of the workpiece 120 and to increase the deposition rate V on the upper layer side of the workpiece 120.

The three-dimensional building method using the three-dimensional building apparatus 10 includes [1] an ejecting step (S42b) of ejecting droplets 30 of the model material 104 and the support material 106 toward the uppermost surface 108 of the deposition structure 102 formed by depositing the unit layers 151 to 158, while moving relative to the stage 20 configured to hold the deposition structure 102, [2] a curing step (S44) of curing the uppermost surface 108 formed through ejection of the droplets 30, and [3] a control step (S42a) of performing ejection control so as to reduce the deposition rate V on the lower layer side of the workpiece 120 and to increase the deposition rate V on the upper layer side of the workpiece 120.

The shearing stress acting between the unit layers 151 to 158 due to the effect of the weight of the workpiece 120 tends to increase on the lower layer side and decrease on the upper layer side. The ejection control of the ejection unit 32 is then performed such that the deposition rate V is reduced on the lower layer side of the workpiece 120, whereby the time required for the unit layers 151 to 158 on the lower layer side to be completely cured becomes relatively short, and variation in curing properties is less likely occur. Accordingly, a three-dimensional object 100 with sufficient adhesion between the unit layers 151 to 158 can be generated without performing a special process before curing the model material 104 and the support material 106.

On the other hand, ejection control of the ejection unit 32 is performed such that the deposition rate V is increased on the upper layer side of the workpiece 120, so that the time required for completion is reduced accordingly, and the productivity of the workpiece 120 is improved. It should be noted that on the upper layer side where the stress due to the weight of the workpiece 120 is low, even when the time required for curing is relatively long, the adhesion as described above is less affected.

[Remarks]

The present disclosure is not intended to be limited to the foregoing embodiment and can be modified as desired without departing from the scope of the disclosure, as a matter of course.

For example, although the deposition rate V is changed discretely in three levels according to the position in the Z direction in this embodiment (FIG. 5), the number of rate levels may be two, or four or more, rather than three. The position dependency of the deposition rate V may be in the form of any functions having continuity or discontinuity.

The deposition rate V may be changed by changing the scanning rate, in addition to variably controlling the deposition interval and the ejection amount. For example, the deposition rate V may be decreased by reducing the scanning rate, that is, increasing the time interval between the ejection timings.

Although both the stage 20 and the ejection unit 32 are movable in the present embodiment, one may be fixed while the other may be movable, and three moving directions (the X direction, the Y direction, and the Z direction) may be combined as desired.

Although the inkjet-type three-dimensional building apparatus 10 has been described in the present embodiment, the present disclosure is not limited to this building method. For example, the disclosure is also applicable to fused deposition modeling, stereo lithography, selective laser sintering, projection, and binder jetting.

What is claimed is:

1. A three-dimensional building apparatus that generates a three-dimensional object formed of a curable model material, by removing a support member formed of a curable support material from a workpiece obtained by successively depositing unit layers including the curable model material and/or the curable support material, the three-dimensional building apparatus comprising:
a stage, configured to hold a deposition structure formed by depositing the unit layers;
an ejector, configured to eject droplets of the curable model material and the curable support material toward an uppermost surface of the deposition structure while moving relative to the stage;
a curing device, configured to cure the uppermost surface formed through ejection of the droplets; and
an ejection controller, configured to perform an ejection control of the ejector so as to reduce a deposition rate on a lower layer side of the workpiece and to increase a deposition rate on an upper layer side of the workpiece.

2. The three-dimensional building apparatus according to claim 1, wherein
the ejection controller performs the ejection control of the ejector, so as to reduce a deposition interval and reduce an ejection amount of the droplets on the lower layer side of the workpiece and to increase a deposition interval and increase an ejection amount of the droplets on the upper layer side of the workpiece.

3. The three-dimensional building apparatus according to claim 1, wherein
the support member that is part of the workpiece includes a pedestal disposed between the three-dimensional object and the stage.

4. The three-dimensional building apparatus according to claim 2, wherein
the support member that is part of the workpiece includes a pedestal disposed between the three-dimensional object and the stage.

5. A three-dimensional building method in which a three-dimensional object formed of a curable model material is generated by removing a support member formed of a curable support material from a workpiece obtained by successively depositing unit layers including the curable model material and/or the curable support material, the three-dimensional building method comprising:
an ejecting step of ejecting droplets of the curable model material and the curable support material toward an uppermost surface of a deposition structure formed by depositing the unit layers, while moving relative to a stage configured to hold the deposition structure;
a curing step of curing the uppermost surface formed through ejection of the droplets; and
a control step of performing an ejection control so as to reduce a deposition rate on a lower layer side of the workpiece and to increase a deposition rate on an upper layer side of the workpiece.
